(19) United States
(12) Patent Application Publication
(10) Pub. No.: US 2003/0176563 A1
(43) Pub. Date: Sep. 18, 2003

(54) Acrylic fiber with excellent appearance and woven pile fabric

(76) Inventors: Minoru Kuroda, Hyogo (JP); Shoichi Murata, Hyogo (JP); Satoru Harada, Hyogo (JP)

Correspondence Address: BRINKS HOFER GILSON & LIONE, P.O. BOX 10395, CHICAGO, IL, 60611, US

(21) Appl. No.: 10/343,144

(22) PCT Filed: Jul. 26, 2001
(86) PCT No.: PCT/JP01/06438

(30) Foreign Application Priority Data
Jul. 28, 2000 (JP) 2000-228908
Aug. 18, 2000 (JP) 2000-248406

(51) Int. Cl. C08K 3/22

(52) U.S. Cl. 524/497

(57) ABSTRACT

Acrylic fiber which can be produced industrially at a low cost and has excellent appearance properties that the individual fibers are clearly perceived visually is provided.

The object is attained by using an acrylic fiber comprising an acrylic copolymer, which has a light transmittance of 15 to 65% in the fiber width direction and a maximum surface reflectance of 30 to 80% with respect to light incident thereon at an angle of 60 degrees in the fiber length direction, wherein the fiber contains 1.2 to 30 parts by weight of white pigment having a maximum particle size of at most 0.8 μm based on 100 parts by weight of the acrylic copolymer.

### TECHNICAL FIELD

The present invention relates to an acrylic fiber having excellent appearance properties that the individual fibers are clearly perceived visually when used in a standing fabric, and a pile fabric using the same.

### BACKGROUND ART

Acrylic fibers have texture and gloss like animal hair, and are widely used in the field of knit, boa and high pile. Recently, a demand for bringing the appearance and texture of the pile close to that of natural furs by using these acrylic fibers has been increased. In general, natural furs have a two-layer structure of guard hair (long hair) and down hair (short hair). The characteristics of furs vary depending on animals, and there are a fur in which the hue of the individual hair is changing in the length direction of the hair as in chinchilla, and a fur which has a two layer structure of long and thick guard hair and thin and short down hair as in mink. Pile products comprising a synthetic fiber are products which imitate such structures very closely. Generally, acrylic fibers used in the field of such pile products are designed to have a blocking effect by compounding a metal compound into fibers in order to bring the gloss close to that of the natural animal hair.

For example, JP-A-56-44163 and JP-A-56-44164 suggests a method of preparing acrylic fiber having gloss like animal hair by adding a metal compound and a cellulose derivative to a copolymer comprising acrylonitrile.

Furthermore, JP-A-3-146705 discloses that a gloss much closer to that of animal hair is exhibited when cracks are formed perpendicularly to the fiber axis direction by rapidly cooling and overdrawing a dried acrylic synthetic fiber containing a metal compound, during the spinning step. However, although the fibers obtained by these techniques apparently have appearance like animal hair, the impression of the individual fibers buried in other surrounding fibers remains when used in a standing fabric.

To solve these conventional problems, in JP-A-62-177255 an attempt is made to highlight the color of the fiber by forming voids in the cross section of the fiber by vaporization of a solvent of low boiling point and utilizing the visual effect of the irregular light reflection occurring in the internal structure of the fiber. However, since a solvent of low boiling point is used as a foaming agent in this technique, there arises the problem of collecting the low-boiling point solvent, and the technique was not industrially satisfactory in terms of cost.

The object of the present invention is to provide an acrylic fiber which can be produced industrially at a low cost and have excellent appearance properties that the individual fibers are clearly perceived visually, and a pile fabric using the same.

### DISCLOSURE OF INVENTION

As a result of intensive studies on light transmittance (opacity) and maximum surface reflectance of fiber to solve the above problems, it has been found that the fiber having a particular light transmittance and maximum surface reflectance exhibits excellent appearance properties that the individual fibers are clearly perceived visually, and the present invention has been accomplished.

That is, the present invention relates a synthetic acrylic fiber comprising an acrylic copolymer, which has a light transmittance of 15 to 65% in the fiber width direction and a maximum surface reflectance of 30 to 80% with respect to light incident thereon at an angle of 60 degrees in the fiber length direction.

It is preferable that the synthetic acrylic fiber contains 1.2 to 30 parts by weight of white pigment having a maximum particle size of at most 0.8 μm, based on 100 parts by weight of the acrylic copolymer.

Preferably, the white pigment is titanium oxide.

It is preferable that the acrylic copolymer comprises 35 to 98% by weight of acrylonitrile, 65 to 2% by weight of another vinyl monomer copolymerizable with acrylonitrile and 0 to 10% by weight of a sulfonic acid group-containing vinyl monomer copolymerizable therewith.

Preferably, the other vinyl monomer copolymerizable with acrylonitrile is vinyl chloride and/or vinylidene chloride.

It is preferable that the fiber has a flat cross section with a flating ratio of 7 to 25, which is the ratio of the minimum value of the long axis to the maximum value of the short axis.

Preferably, the flating ratio is 10 to 20.

The present invention also relates to a pile fabric containing, in the pile portion, at least 3% by weight of the acrylic fiber based on the entire pile portion.

It is preferable that in the pile fabric, the hue L_{A} of the acrylic fiber and the hue Lᵢ of the fiber other than the acrylic fiber satisfy |L_{A}−Lᵢ|>30.

The present invention also relates to a step pile fabric having at least a long pile portion and a short pile portion, wherein the long pile portion contains the acrylic fiber.

It is preferable that the pile fabric comprises 5 to 60% by weight of the acrylic fiber based on the entire pile portion.

It is preferable that in the step pile fabric, the difference between the pile length of the fiber of the long pile portion and the pile length of the fiber of the short pile portion is at least 2 mm, and the pile length of the fiber of the long pile portion is 12 to 70 mm.

It is preferable that in the step pile fabric, the hue L_{A} of the acrylic fiber and the hue Lᵢ of the fiber other than the acrylic fiber satisfy |L_{A}−Lᵢ|>30.

### BRIEF DESCRIPTION OF THE DRAWINGS

FIG. 1 is a view illustrating the position of the incident light when the light transmittance of fiber with a flat cross section is measured.

FIG. 2 is a view illustrating the position of the incident light when the light transmittance of fiber with an oval cross section is measured.

FIG. 3 is a view illustrating the position of the incident light when the light transmittance of fiber with a circular cross section is measured.

FIG. 4 is a view illustrating the position of the incident light when the light transmittance of fiber with a cross-shaped cross section is measured.

FIG. 5 is a view illustrating the direction of the sample when the maximum surface reflectance with respect to light incident on the fiber is measured.

FIG. 6 is a view illustrating the step of a three-step pile.

### BEST MODE FOR CARRYING OUT THE INVENTION

The light transmittance in the fiber width direction in the present invention is obtained by microscopic-measurement of visible spectra. The microscopic-measurement of visible spectra is carried out by using apparatus comprising a microscope, a spectroscope and an optical fiber connecting them. In measurement, an image enlarged by the objective lens of the microscope is formed on one end of the optical fiber, whereby the light of the measurement site incidents upon the fiber, and this incident light is led to the spectroscope where the light divided into spectra is received.

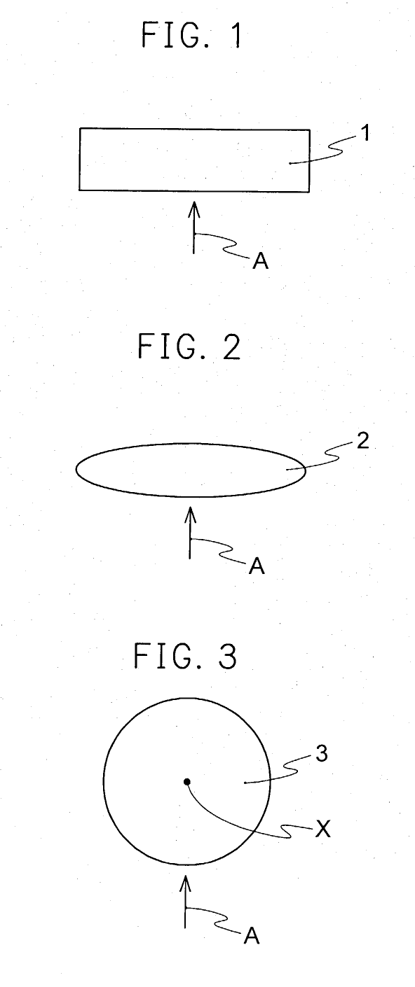

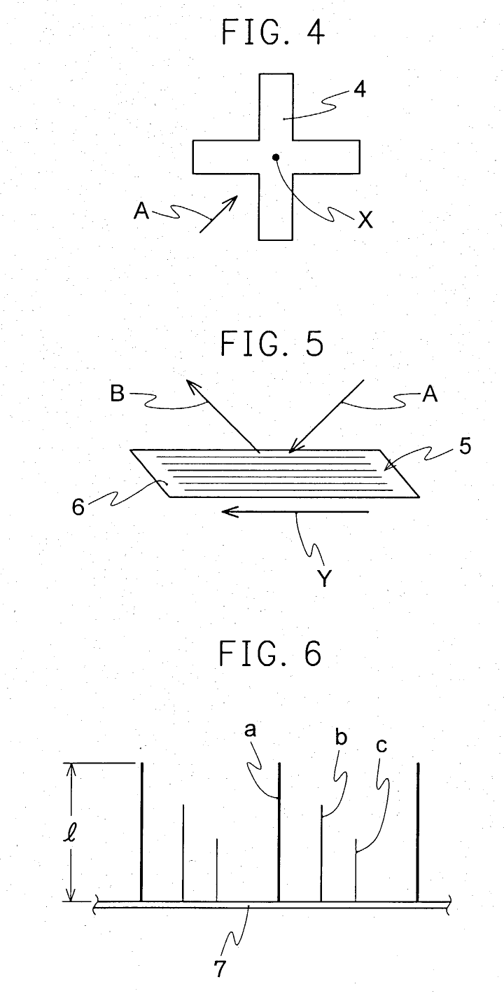

Specifically, the incident light A is preferably measured by incidence in the width direction of the cross section of the fiber. For example, the measurement was carried out by incidence of the light, into the maximum part of the short axis in the width direction in the case of fiber with a flat cross section 1, oval cross section 2 or dog bone-shaped cross section (e.g., FIGS. 1 and 2); into the center X of the cross section in the case of fiber with a circular cross section 3 or triangle cross section (e.g., FIG. 3); and in the center X of the cross section directly in the case of fiber with a Y-shaped cross section or cross-shaped cross section 4 (e.g., FIG. 4).

The measurement is carried out in the visible light range of a wavelength of from 400 to 700 nm. The light transmittance at 550 nm needs to be 15 to 65%. More preferably, the light transmittance is 25 to 55%. When the light transmittance of the fiber is less than 15%, the texture of the fiber becomes so-called “kempy wool”—like with inferior gloss, resulting in insufficient appearance properties that individual fibers are not clearly perceived visually. When the light transmittance of the fiber is more than 65%, the fiber becomes transparent, and when used as a pile fabric, the boundaries of individual fibers become indistinct due to “lack of hiding”. As a result, the fiber has poor color difference effect and inferior appearance properties that the individual fibers are not clearly perceived visually.

The maximum surface reflectance in the present invention is measured by a method of using an automatic angle controlling spectrometer, in which incident light A is applied from a standard light source at a prescribed angle to the surface of the sample to measure the reflected light B with a light receiver. For example, the test method of JIS-K7105 may be used.

In the present invention, the maximum surface reflectance needs to be 30 to 80% when the light incident angle from the standard light source in the fiber length direction Y is 60 degrees and the reflected component therefrom is measured with a light receiver at a receiving angle of 0 to 90 degrees. More preferably, the maximum surface reflectance is 40 to 75%. When the maximum surface reflectance of the incident light at an incident angle of 60 degrees is less than 30%, the fiber becomes so-called “kempy wool”—like with inferior gloss, resulting in insufficient appearance properties that the individual fibers are not clearly perceived visually. When the maximum surface reflectance is more than 80%, individual fibers have too much gloss and the surface assumes glaring and metallic texture.

The acrylic fiber of the present invention is a fiber comprising an acrylic copolymer. Preferably, the acrylic copolymer comprises 35 to 98% by weight of acrylonitrile, 65 to 2% by weight of another vinyl monomer copolymerizable with acrylonitrile and 0 to 10% by weight of a sulfonic acid group-containing vinyl monomer copolymerizable with the monomers. More preferably, the acrylic copolymer comprises 35 to 90% by weight of acrylonitrile, 64.7 to 9.7% by weight of another vinyl monomer copolymerizable with acrylonitrile and 0.3 to 3% by weight of a sulfonic acid group-containing vinyl monomer copolymerizable with the monomers. When the amount of acrylonitrile is less than 35%, situations are not preferable as texture tends to be sticky and less voluminous, and special conditions are requested in the finishing step such as polisher step. When the amount of acrylonitrile is more than 98%, there is a tendency that the texture becomes rough and dying properties become inferior due to the decrease of dye sites. Furthermore, when the amount of another vinyl monomer copolymerizable with acrylonitrile is less than 2% by weight, there is a tendency that the texture becomes rough and dying properties become inferior. When another vinyl monomer copolymerizable with acrylonitrile is more than 65%, situations are not preferable as the texture bears less resemblance to animal hair and special conditions are requested in the finishing step. When the amount of sulfonic acid group-containing vinyl monomer is more than 10%, dissolution is not sufficient when preparing spinning solution, and the spinning stability tends to be adversely affected. Furthermore, situations are not preferable because there is no reasonable effect on dying properties in terms of the added amount.

Examples of the vinyl monomer copolymerizable with acrylonitrile include vinyl halides and vinylidene halides such as vinyl chloride, vinylidene chloride, vinyl bromide and vinylidene bromide; unsaturated carboxylic acids such as acrylic acid and methacrylic acid, and a salt thereof; acrylic esters and methacrylic esters such as methyl acrylate and methyl methacrylate; esters of unsaturated carboxylic acid such as glycidyl methacrylate; vinyl esters such as vinyl acetate and vinyl butyrate; vinyl amides such as acrylamide and methacrylamide; and other known vinyl compounds such as methallyl sulfonate, vinyl pyridine, methyl vinyl ether and methacrylonitrile. The acrylic copolymer may be obtained by copolymerizing one or at least two of these monomers. Among these, vinyl chloride and/or vinylidene chloride is preferred since high flame retardancy can be imparted and maintained.

As the sulfonic acid group-containing vinyl monomer, styrene sulfonic acid, p-styrene sulfonic acid, allyl sulfonic acid, methallyl sulfonic acid, p-methacryloyloxybenzene sulfonic acid, methacryloyloxypropyl sulfonic acid, or a metallic salt and amine salt thereof may be used. Among these, styrene sulfonic acid is preferred.

These acrylic copolymers may be obtained by a usual polymerization method, using known compounds as a polymerization initiator, for example, peroxide compounds, azo compounds or various redox-type compounds.

The white pigment used in the present invention is generally an additive in the form of fine powder of inorganic compound. Concrete examples of the white pigment are titanium oxide, zinc oxide, zirconium oxide, tin oxide, aluminium oxide, silicon oxide, magnesium oxide, calcium oxide, antimony oxide, titanium hydroxide, zinc hydroxide, zirconium hydroxide, aluminium hydroxide, magnesium hydroxide, lead hydroxide, barium sulfonate, calcium sulfonate, zinc sulfonate, aluminium phosphate, calcium phosphate, calcium carbonate, lead carbonate, barium carbonate, magnesium carbonate and the like. Among these, titanium oxide is preferred since it has high refractive index and high concealment.

In the present invention, it is preferable to add 1.2 to 30 parts by weight of highly dispersible white pigment having a maximum particle size of at most 0.8 μm based on 100 parts by weight of the acrylic polymer. The amount of white pigment is more preferably 2 to 15 parts by weight. When the amount of white pigment is less than 1.2 parts by weight, transparency of individual fibers increases, and when the fiber is used in a pile fabric, the difference of brightness becomes small and the boundaries of individual fibers become indistinct due to “lack of hiding”, and the appearance properties tend to be inferior. When the amount of white pigment is more than 30 parts by weight, not only the mechanical properties of the obtained fiber are adversely affected but also productivity tends to be decreased.

Preferably, the maximum particle size of white pigment is at most 0.8 μm. More preferably, the maximum particle size is 0.4 μm. As mentioned above, a technique of adding an inorganic pigment as a delustering agent to a copolymer comprising acrylonitrile, is widely known as in JP-A-56-44163 and JP-A-56-44164. Among the inorganic pigments, titanium oxide has been widely used since it has high refractive index and high concealment. However, since titanium oxide has an active particle surface, it has low dispersibility, particularly in polar organic solvents. Therefore, when titanium oxide is dispersed in an organic solvent and the dispersion is added to a spinning solution of an acrylic polymer in a large amount, the titanium oxide dispersed in the solution aggregates and deposits on the filter. As a result, the filter is clogged to cause remarkable decrease in filterability. Thus stable and continuous production of fibers has not been realized on an industrial basis. On the other hand, as disclosed in JP-A-3-50120, JP-A-6-145552 and JP-A-9-25429, in the case of using highly dispersible white pigment which has a maximum particle size of at most 0.8 μm and is subjected to surface modification, the aggregation of titanium oxide dispersed in the solution can be prevented. The life of the filter is thus extended in filterability, making it possible to produce fibers stably and continuously on an industrial basis. Furthermore, the acrylic fiber obtained by adding such titanium oxide has not only a decreased gloss as known before, but also excellent appearance properties that the individual fibers are clearly perceived visually due to the high concealment of titanium oxide.

Thus when an inorganic compound having a maximum particle size of more than 0.8 μm is used, filterability is decreased due to aggregation of the compound dispersed in the solution, and stable and continuous production of fibers on an industrial basis becomes difficult.

Furthermore, the acrylic fiber obtained by adding white pigment having a maximum particle size of more than 0.8 μm has poor concealing effect. Therefore the special coloring in the pile fabric is not clearly perceived visually.

The method of adding and mixing white pigment to the spinning solution of acrylic copolymer includes: a method of adding white pigment directly to a tank for spinning solution of an acrylic copolymer with stirring, and degassing the solution to give a spinning solution; or a method of adding white pigment using a line mixer such as a dope grinder and static mixer in the step just before the arrival at the spinning nozzle in the spinning solution delivery line; and the like.

The spinning solution may be obtained by dissolving the copolymer in an organic solvent which has a high solubility for the copolymer, and a general dissolution method known in the art may be used. Examples of the solvent used to dissolve the copolymer in the spinning solution include organic solvents such as acetone, acetonitrile, dimethylformamide, dimethylacetamide and dimethylsulfoxide, rhodan salts such as sodium rhodanide, potassium rhodanide and ammonium rhodanide, and a thick solution of an inorganic salt such as zinc chloride or lithium chloride. Among these, acetone and dimethylacetamide are preferred. The concentration of the polymer in the spinning solution is generally adjusted to 20 to 35% by weight, preferably 25 to 32% by weight in view of spinning property and stability of the steps.

The spinning method of the acrylic copolymer include wet spinning method, dry spinning method and semi-dry semi-wet spinning method, while the wet spinning method is generally used.

The shape of the cross section of the acrylic fiber of the present invention include, and not limited to, circular cross section, triangle cross section, flat cross section, oval flat cross section, dog bone-shaped cross section, Y-shaped cross section, cross-shaped cross section and the like. Among these, flat cross section, oval flat cross section and dog bone-shaped cross section are preferred. The flating ratio which is the ratio of the minimum value of the long axis to the maximum value of the short axis of the cross section is preferably 7 to 25. The lower limit of the flating ratio is more preferably 10, and still more preferably 14. The upper limit of the flating ratio is more preferably 20. When the fiber has a flat cross section, the long axis means the long side of the rectangle which is circumscribed with the cross section of the fiber. On the other hand, the shot axis means the short side of the rectangle. When the fiber has a cross section other than flat, the long axis means the maximum distance between the two parallel tangents of the cross section of the fiber. On the other hand, the short axis means the width of the cross section of the fiber, namely the distance between the two tangents parallel to the long axis direction, i.e., the maximum breadth direction. When the flating ratio is less than 7, the width of the fiber, which is visually important, is decreased, resulting in a tendency that individual fibers cannot be clearly perceived. Furthermore, the light reflection tends to be insufficient because the smooth surface which contributes to the glossiness becomes small. On the other hand, when the flating ratio is more than 25 and the fiber is observed perpendicularly to the long axis direction, lack of hiding is more remarkable. Moreover, the cross section of the fiber tends to be easy to split.

The denier of the individual fibers of the acrylic fiber is preferably 3 to 50 decitex (hereinafter dtex). In particular, a range of 5 to 30 dtex is more preferable since the characteristic of individual fibers clearly perceived visually is easily exhibited. When the denier of the individual fibers is less than 3 dtex, the fiber is too thin, resulting in a tendency that the appearance of the individual fibers is not clearly perceived when the fiber is used for pile fabric. On the other hand, when the denier of the individual fibers is more than 50 dtex, the fiber tends to be too thick and the texture of the pile fabric tends to become rough.

The pile fabric of the present invention contains the acrylic fiber as the fiber constituting the pile portion, in an amount of at least 3% by weight, preferably 5 to 70% by weight based on the entire pile portion. When the percentage of the acrylic fiber in the entire pile portion is less than 3% by weight, other fibers structurally dominate the portion, and excellent appearance properties that the individual fibers are clearly perceived visually tends to be difficult to be obtained.

The pile portion of the present invention refers to, as shown in FIG. 6, a standing portion excluding the base fabric 7 (ground yarn portion) of the pile fabric (standing fabric). The pile length 1 is the length from the root to the tip of the standing portion. The pile length 1 is not particularly limited. Preferably, the pile length 1 is 12 to 28 mm.

There are various types of pile fabric such as a pile fabric of fixed pile length and a mixed pile fabric of long and short pile portions. The pile fabric of the present invention may be a pile fabric of fixed pile length and a mixed pile fabric of long and short pile portions. Among these, pile fabric with steps, such as two-step pile of long pile portion a and short pile portion c or three-step pile of long pile portion a, middle pile portion b and short pile portion c, is more preferable. In the three-step pile of FIG. 6, for example, the long pile portion a is the portion of the longest pile, so-called guard hair portion. The middle portion b is the portion of the second longest pile after the long pile portion, so-called middle hair portion, and in addition, the short pile portion c is the portion of the shortest pile, so-called down hair. The step of the present invention refers to, in the two-step pile, the difference between the portion a and the portion c. In the three or more-step pile, the step is the difference between the portion a and the longest pile in the portion b (when the portion b has two steps, the longer pile). Such steps can be made, for example, by using shrinkable fiber or fiber of various cut lengths.

Another constitution of the pile fabric of the present invention is a pile fabric with step, which comprises the acrylic fiber as the fiber constituting the long pile portion of the pile fabric. The amount of the acrylic fiber constituting the long pile portion is preferably 5 to 60% by weight, more preferably 5 to 30% by weight based on the entire pile portion. When the acrylic fiber is used for the long pile portion, the pile fabric obtained therefrom has excellent appearance properties because the acrylic fiber of the present invention excellent in appearance properties is used as guard hair. When the percentage of the acrylic fiber constituting the long pile portion is less than 5% by weight and other fibers are used as guard hair, there is a tendency that the acrylic fiber is buried in these fibers and sufficient effect of appearance properties cannot be exhibited. When the percentage is more than 60% by weight, the percentage of the acrylic fiber in the pile fabric also increases, resulting in a tendency that the step effect between the guard hair portion and the portion of other fibers (other than the guard hair portion) cannot be sufficiently exhibited.

The percentage of the long pile portion to other pile portions (middle pile portion and short pile portion) based on the entire pile portion is preferably long pile portion/other pile portions=10 to 85% by weight/90 to 15% by weight. When the percentage of the long pile portion is less than 10% by weight of the entire pile portion, the amount of the long pile portion is extremely small and the balance between the long pile portion and the short pile portion is lost, resulting in the problem of non-recovery, and thus the commercial value is decreased. When the percentage of the long pile portion is more than 85% by weight of the entire pile, pile fabric tends to lack volume. When the percentage of other pile portions is less than 15% by weight of the entire pile, bluming effect becomes good but the pile fabric tends to lack volume. When the percentage of other pile portions is more than 90% by weight, the balance between the long pile portion and the short pile portion is lost, resulting in the problem of non-recovery and poor bluming effect, and thus the commercial value is decreased.

In the pile fabric with steps, the difference (step) between the average pile length of the fibers constituting the long pile portion a and the average pile length of the fibers constituting the short-pile portion c (in the case of a pile of three or more steps, the second longest pile portion of the pile portions after the long pile portion, e.g., pile portion b) is preferably at least 2 mm. More preferably, the difference between the average pile length of the long pile portion and that of the short pile portion is at least 3 mm. When the step is less than 2 mm, the boundary of guard hair and down hair becomes indistinct, and consequently, the effect of the present invention, which is more remarkable when the step effect is exhibited, becomes insufficient. The average pile length of the fibers constituting the long pile portion a is preferably 12 to 70 mm. More preferably, the average pile length of the long pile portion a is 15 to 50 mm. When the average pile length of the long pile portion a is shorter than 12 mm, sufficient step effect is not observed and remarkable effect cannot be easily exhibited even if there is a significant step between the long pile portion and the short pile portion. On the contrary, when the average pile length of the long pile portion a is more than 70 mm, the acrylic fiber in the pile fabric lack resilience, and the quality of the obtained standing product tends to be unsatisfactory.

The average pile length is represented by the average value of the measurement of the length 1 at ten points in a pile fabric. The length 1 is the length from the root (on the surface of the pile fabric 7) to the tip of the fiber constituting the pile portion, when the fiber is stood upright so as to make the lie of the fiber even.

The pile fabric with step is preferably a two-step pile of a long pile portion and a short pile portion, while a three-step pile further comprising a middle pile portion (middle hair) may also be used.

The hue L_{A} of the acrylic fiber constituting the pile fabric and the hue Lᵢ of the fiber other than the acrylic fiber preferably satisfy |L_{A}−Lᵢ>30, more preferably |L_{A}−Lᵢ>50. When two or more kinds of fibers are used in addition to the acrylic fiber to make up the pile fabric, each Lᵢ is represented by L₁, L₂, and so on. It is preferable that each Lᵢ value satisfies the above formula. When the difference of the hues |L_{A}−Lᵢ| is less than 30, the hue difference between the acrylic fiber and the fiber other than the acrylic fiber is small, and the effect of the present invention that the individual fibers in the pile fabric are clearly perceived visually is difficult to be exhibited. The tendency is more remarkable in the case of the pile fabric of even pile length without step. The hue L_{A} is preferably at least 70. The upper limit of the hue L_{A} is not particularly limited, and there is no problem even if the fiber with a hue L_{A} of more than 100, which is obtained by using a fluorescent bleach, is used. When the hue L_{A} is less than 70, reflected light from the individual fibers is decreased (absorbed light is increased), and the effect that the individual fibers are perceived visually tends to decrease.

The hue L is a criteria for colors measured by a color difference meter. In the present invention, the hue L is measured by a color difference meter Type Σ90 made by Nippon Denshoku Kogyo Co., Ltd, but the color difference meter is not particularly limited. The closer to 100 the hue L is, the closer to white the color is, and the closer to 0 the hue L is, the closer to gray and black the color is. Furthermore, there is another criteria for colors, that is, color a and b, which are represented by + and −. When the color a is on the + side and the larger the value, the higher the degree of red. When the color a is on the − side and the larger the value, the higher the degree of green. When the color b is on the +side and the larger the value, the higher the degree of yellow. When the color b is on the − side and the larger the value, the higher the degree of blue. These L, a and b are called the Hunter's Lab coloring system. In particular, the L value represents the brightness and darkness of the color and is suitable for describing the effect of the present invention.

The flating ratio, denier and pile length of the pile fabric of the acrylic fiber of the present invention which has excellent appearance properties can be changed depending on the planning of product lines. When the acrylic fiber of high flating ratio and thick denier is used in the guard hair portion of the pile fabric, the finished texture of the fabric is more clearly perceived visually. When the percentage of the acrylic fiber in the guard hair portion of the pile fabric is decreased, the acrylic fiber is distinguished one by one and exhibits an excellent visually effect. In addition, since the non-bundling is more significant, the fabric exhibits excellent bluming effect and texture like animal hair.

In the followings the present invention is explained in detail by means of the Examples, but the present invention is not limited thereto. Before describing Examples, the analysis and measurement conditions as well as the evaluation method are explained.

(A) Measurement of Light Transmittance

A metal system microscope (made by Olympus Optical Co., Ltd.) was used. The light transmittance of various individual fibers with uniform hue was evaluated by measuring the light transmittance at two points for each of the five samples (10 points in total). The magnification of the objective lens was 50 magnifications (N.A.=0.70, β=89°) and the measurement area was φ 20 μm. A transmission bright field-type halogen lamp was used as a light source. By using an instantaneous multi-channel photometer system MCPD-113 (made by Otsuka Electronics Co., Ltd.) as a spectrometer, measurement was carried out at a visible light area of from 400 to 700 nm under conditions of a resolution of 2.4 nm in an accumulation of four times up to accumulation time of 20,000 msec. The average value was assumed to be the light transmission.

The preferred positions of the incident light A for each cross section are shown in FIGS. 1 to 4.

(B) Measurement of Maximum Surface Reflectance

An automatic angle controlling spectrometer GP-200 (made by Murakami Color Laboratories, Ltd.) was used. The maximum surface reflectance of each of the five samples with uniform hue was measured to evaluate the surface gloss. In accordance with JIS-K7105, fiber 5 of a length of 50 mm and a total denier of 30,000 dtex was put on a sample table 6 by clipping both ends of the fiber in the length direction Y of the sample without creating unevenness, and the reflected light A with respect to light incident at an angle of 60 degrees was measured under the conditions of a light receiving aperture of 4.5 mm, a light receiving angle of 0 to 90 degrees and a light receiving revolving angle velocity of 180 degrees/min. Halogen lamps of 12 V and 60 W were used as the standard light source. The applied voltage of the photomultiplier was set to −593 V.

The direction of light incidence and the direction of light reflectance on a test specimen are shown in FIG. 5.

(C) Measurement of Particle Distribution

A transmission centrifugation sedimentation measurement apparatus SA-CP4L made by Shimadzu Corporation was used. A sample was prepared by dissolving, in acetone, DISCOL 206 (general name: polyalkyleneoxide polyamine) available from Daiichi Pharmaceutical Co., Ltd., adjusting the liquid specific gravity to 0.814 g/cm³ and the liquid viscosity to 0.798 MPa, and the prepared sample was filled in a predetermined cell. Thereto was added dropwise 10 mg of pigment dispersed in acetone in a concentration of 1.5% by weight, and the measurement was carried out. The dispersion of the pigment was added to the acetone solution of DISCOL 206 in order to reduce sedimentation ratio by increasing the viscosity of the dispersion.

(D) Production of High Pile Fabric

The obtained fiber was subjected to the required treatment and operation such as oiling, mechanical crimping and cut. The mechanical crimping means crimping obtained by the known method such as gear crimping method and stuffing box method, and is not particularly limited. Preferred shape of the crimp is those having a crimp degree of 4 to 15%, preferably 5 to 10%. The number of the peaks of the crimp is 6 to 15 peaks/inch, more preferably 8 to 13 peaks/inch. The crimp degree is obtained by the measuring method defined in, for example, JIS-L1074. Then the fiber was cut and knitted with a sliver knitting machine to compile a pile fabric. Then the pile fabric was subjected to pre-polishing and pre-shirring at 120° C. so as to make the pile length even, and back coating was carried out on the reverse side of the pile by using an acrylic ester adhesive. Thereafter polishing at 155° C. and brushing were carried out, and in addition, polishing and shirring were conducted together at 135° C., 120° C. and 90° C. (each being conducted twice) to remove the crimp on the surface of the standing portion, and thus a standing fabric having even pile length was produced.

(E) Sensory Evaluation of Appearance Properties

The pile fabric produced as above was subjected to three-level sensory evaluation in view of the degree of appearance properties, i.e., whether or not the individual fibers constituting the pile are clearly perceived visually. The evaluation was conducted based on the following criteria.

O: Pile fabric has appearance properties that the individual fibers are clearly perceived

Δ: Appearance of individual fibers of the pile fabric is inferior

x: Appearance of individual fibers of the pile fabric is extremely inferior

(F) Advantage in Stable Industrial Production

The advantage in terms of cost, stability of spinning step and productivity when producing the acrylic fiber industrially was evaluated based on the following criteria.

O: Extremely advantageous for stable industrial production

Δ: Stable industrial production is difficult

x: Stable industrial production is impossible

(G) Measurement of Average Pile Length

The fiber constituting the pile portion of the pile fabric was stood upright so as to make the lie of the fiber even, and the length from the root (on the surface of the pile fabric) to the tip of the fiber constituting the pile portion was measured at ten points by using a vernier caliper. The average value was assumed to be the average pile length.

(H) Measurement of Surface Reflectance and Brightness of Pile Fabric

The measurement using the pile fabric was carried out by using a color difference meter CR-310 (tristimulus value type) made by Minolta Co., Ltd. The pile fabric was cut into 100 cm×165 cm, and the standing portion of the pile fabric was laid down evenly in the direction of the lie of the fiber. The measurement was carried out by lightly pressing down the handy-type measurement head on the pile fabric prepared by the above method, in the direction of the lie of the fiber of the pile fabric. In this case, as a light shielding cylinder tube of the measurement head, one in which a glass plate can be set was used, in order to avoid the lie of the fiber of the pile fabric being ruffled. Furthermore, a measurement meter of the light shielding cylinder tube of 50 mm was used in order to carry out the evaluation in a wide visual field. The measurement was conducted at ten points of the fabric, and the average values were assumed to be the surface reflectance and the brightness of the pile fabric, respectively.

(I) Measurement of Step in Pile

The step of pile is the difference between the average pile length of the long pile portion and the average pile length of the short pile portion as measured by the above-mentioned methods, and calculated by using the following equation.

Step (mm)=average pile length of long pile portion (mm)−average pile length of short pile portion (mm)

(J) Measurement of Hue

The fiber of each portion (the portion of the acrylic fiber of the present invention and the portion of other fibers) was weighed out in a fixed amount and put into a sample table having a diameter of 30 mm. The hue L was measured by using a color difference meter Type Σ 90 (made by Nippon Denshoku Kogyo Co., Ltd.) equipped with a light source similar to the standard light source C defined in JIS Z 8720. In this measurement, the density of the sample was set to 0.16 g/cm³.

### EXAMPLE 1

An acrylic copolymer comprising 49 parts by weight of acrylonitrile (hereinafter AN), 50 parts by weight of vinyl chloride (hereinafter VCL) and 1 parts by weight sodium styrene sulfonate was dissolved in acetone. A spinning solution was prepared by adding 5 parts by weight of titanium oxide having a superior dispersibility and a maximum particle size of at most 0.8 μm (A-160 available from Sakai Chemical Industries, Co., Ltd.) based on 100 parts by weight of the acrylic copolymer. Wet spinning was carried out by passing the spinning solution through a spinneret of a pore size of 0.8×0.06 mm and a pore number of 3,900 in a solidification bath of an aqueous solution containing acetone in a concentration of 30% by weight. Then while passing the solution through two baths of an aqueous solution containing acetone in a concentration of 35% by weight and 25% by weight respectively, drawing was carried out at a drawing ratio of 2.0. Thereafter primary drawing was carried out in a water washing bath of 90° C. so that the drawing ratio becomes 3.0 including the above. The obtained fiber was subjected to oiling, and then dried in an atmosphere of 110° C. The fiber was then subjected to further drawing so that the final draft ratio becomes 6.5, and relaxation heat treatment in a dry-heating atmosphere of 145° C., and the acrylic fiber of the present invention was obtained. The obtained acrylic fiber had an individual fiber denier of 16.5 dtex and a flat cross section with a flating ratio of 14.

### EXAMPLE 2

The acrylic fiber of the present invention was prepared in the same manner as in Example 1, except that the amount of titanium oxide was 1.5 parts by weight in the spinning solution. The obtained acrylic fiber had an individual fiber denier of 16.5 dtex and a flat cross section with a flating ratio of 14.

### EXAMPLE 3

The acrylic fiber of the present invention was prepared in the same manner as in Example 1, except that the amount of titanium oxide was 10 parts by weight in the spinning solution. The obtained acrylic fiber had an individual fiber denier of 16.5 dtex and a flat cross section with a flating ratio of 14.

### EXAMPLE 4

The acrylic fiber of the present invention was prepared in the same manner as in Example 1, except that a solution obtained by adding 5.0% by weight of titanium oxide having a particle size distribution of from 0.1 to 30 μm, based on 100 parts by weight of the acrylic copolymer of Example 1, was used as a spinning solution. The obtained acrylic fiber had an individual fiber denier of 16.5 dtex and a flat cross section with a flating ratio of 14.

### COMPARATIVE EXAMPLE 1

Acrylic fiber was prepared in the same manner as in Example 1, except that a solution obtained by adding no titanium oxide based on 100 parts by weight of the acrylic copolymer of Example 1, was used as a spinning solution. The obtained acrylic fiber had an individual fiber denier of 16.5 dtex and a flat cross section with a flating ratio of 14.

### COMPARATIVE EXAMPLE 2

Acrylic fiber was prepared in the same manner as in Example 1, except that a solution obtained by adding 0.3 part by weight of the titanium oxide based on 100 parts by weight of the acrylic copolymer of Example 1, was used as a spinning solution. The obtained acrylic fiber had an individual fiber denier of 16.5 dtex and a flat cross section with a flating ratio of 14.

### COMPARATIVE EXAMPLE 3

Acrylic fiber was prepared in the same manner as in Example 1, except that a solution obtained by adding 0.3 part by weight of the titanium oxide and 2.5 parts by weight of cellulose acetate based on 100 parts by weight of the acrylic copolymer of Example 1, was used as a spinning solution. The obtained acrylic fiber had an individual fiber denier of 16.5 dtex and a flat cross section with a flating ratio of 14.

### COMPARATIVE EXAMPLE 4

Acrylic fiber was prepared in the same manner as in Example 1, except that a solution obtained by adding 1.0 part by weight of the titanium oxide and 3.0 parts by weight of aluminum hydroxide based on 100 parts by weight of the acrylic copolymer of Example 1, was used as a spinning solution. The obtained acrylic fiber had an individual fiber denier of 16.5 dtex and a flat cross section with a flating ratio of 14.

### EXAMPLE 5

An acrylic copolymer comprising 93% by weight of acrylonitrile and 7% by weight of vinyl acetate (hereinafter VAc) was dissolved in dimethyl acetamide (hereinafter DMAc). A spinning solution of a polymer concentration of 25% was prepared by adding 5% by weight of titanium oxide having a superior dispersibility and a maximum particle size of at most 0.8 μm based on 100 parts by weight the acrylic copolymer. Wet spinning was carried out by passing the spinning solution through a spinneret of a pore size of 0.8×0.06 mm and a pore number of 3,900 in a solidification bath of an aqueous solution containing DMAc in a concentration of 60% by weight. Then drawing was carried out at a drawing ratio of 5.0 in boiling water while washing off the solvent. Subsequently, an oiling agent was applied to the fiber, and the fiber was dried by using a heat roller of 150° C. Thereafter relaxation treatment in a pressurized steam of a gauge pressure of 0.25 MPa was carried out, and the acrylic fiber of the present invention was obtained. The obtained acrylic fiber had an individual fiber denier of 16.5 dtex and a flat cross section with a flating ratio of 12.

### COMPARATIVE EXAMPLE 5

Acrylic fiber was obtained in the same manner as in Example 5, except that a solution obtained by adding 1.0% by weight of titanium oxide having a superior dispersibility and a maximum particle size of at most 0.8 μm, was used as a spinning solution. The obtained acrylic fiber had an individual fiber denier of 16.5 dtex and a flat cross section with a flating ratio of 12.

TABLE 1

| | | | Amount | | Maximum | Maximum | | |
|---|---|---|---|---|---|---|---|---|
| | | | of white | Light | surface | particle | | |
| | | | pigment | trans- | reflect- | size of | | |
| | Composition | | (part by | mittance | ance | white pigment | Appearance | Production |
| | of polymer | Solvent | weight) | (%) | (%) | (μm) | property | stability |
| Ex. 1 | AN/VCL | Acetone | 5.0 | 40.0 | 74.6 | at most 0.8 | ◯ | ◯ |
| Ex. 2 | AN/VCL | Acetone | 1.5 | 47.0 | 52.3 | at most 0.8 | ◯ | ◯ |
| Ex. 3 | AN/VCL | Acetone | 10 | 36.5 | 74.6 | at most 0.8 | ◯ | ◯ |
| Ex. 4 | AN/VCL | Acetone | 5.0 | 40.0 | 76.5 | 30 | Δ | X |
| Ex. 5 | AN/VAc | DMAc | 5.0 | 38.0 | 71.0 | at most 0.8 | ◯ | ◯ |
| Com. | | | | | | | | |
| Ex. 1 | AN/VCL | Acetone | 0 | 95.0 | 90.0 | at most 0.8 | X | ◯ |
| Com. | | | | | | | | |
| Ex. 2 | AN/VCL | Acetone | 0.3 | 73.2 | 45.5 | at most 0.8 | X | ◯ |
| Com. | | | | | | | | |
| Ex. 3 | AN/VCL | Acetone | 0.3 | 68.7 | 40.0 | at most 0.8 | Δ | ◯ |
| Com. | | | | | | | | |
| Ex. 4 | AN/VCL | Acetone | 4.0 | 75.0 | 42.0 | at most 0.8 | X | ◯ |
| Com. | | | | | | | | |
| Ex. 5 | AN/VAc | DMAc | 1.0 | 67.5 | 38.0 | at most 0.8 | X | ◯ |

The results show that Examples 1 to 5 satisfy the requirements of the present invention, whereas Comparative Example 1 does not satisfy the requirement of the maximum surface reflectance, and Comparative Examples 2 to 5 do not satisfy the requirements of the light transmittance and appearance properties of the present invention.

### EXAMPLE 6

70 parts by weight of the fiber obtained in Example 1 (crimped and cut into 51 mm) was blended with 30 parts by weight of a commercially available acrylic fiber “Kanekalon (trade mark)” SL (hereinafter SL, 3.3 dtex, 32 mm, available from Kaneka Corporation) to prepare a pile fabric. The final weight (e.g., g/m²) of the pile fabric was 950 g/m² and the average pile length was 20 mm. As shown in Table 2, the obtained pile fabric exhibited excellent appearance properties that the individual fibers were clearly perceived visually.

### EXAMPLE 7

70 parts by weight of the fiber obtained in Example 2 (crimped and cut into 51 mm) was blended with 30 parts by weight of a commercially available acrylic fiber “Kanekalon (trade mark)” SL (SL, 3.3 dtex, 32 mm, available from Kaneka Corporation) to prepare a pile fabric. The final weight (e.g., g/m²) of the pile fabric was 950 g/m² and the average pile length was 20 mm. As shown in Table 2, the obtained pile fabric exhibited excellent appearance properties that the individual fibers were clearly perceived visually.

### EXAMPLE 8

70 parts by weight of the fiber obtained in Example 3 (crimped and cut into 51 mm) were blended with 30 parts by weight of a commercially available acrylic fiber “Kanekalon (trade mark)” SL (SL, 3.3 dtex, 32 mm, available from Kaneka Corporation) to prepare a pile fabric. The final weight (e.g., g/m²) of the pile fabric was 950 g/m² and the average pile length was 20 mm. As shown in Table 2, the obtained pile fabric exhibited excellent appearance properties that the individual fibers were clearly perceived visually.

### EXAMPLE 9

70 parts by weight of the fiber obtained in Example 5 (crimped and cut into 51 mm) was blended with 30 parts by weight of a commercially available acrylic fiber “Kanekalon (trade mark)” SL (SL, 3.3 dtex, 32 mm, available from Kaneka Corporation) to prepare a pile fabric. The final weight (e.g., g/m²) of the pile fabric was 950 g/m² and the average pile length was 20 mm. As shown in Table 2, the obtained pile fabric exhibited excellent appearance properties that the individual fibers were clearly perceived visually.

### COMPARATIVE EXAMPLE 6

70 parts by weight of the fiber obtained in Comparative Example 1 (crimped and cut into 51 mm) was blended with 30 parts by weight of a commercially available acrylic fiber “Kanekalon (trade mark)” SL (SL, 3.3 dtex, 32 mm, available from Kaneka Corporation) to prepare a pile fabric. The final weight (e.g., g/m²) of the pile fabric was 950 g/m² and the average pile length was 20 mm. As shown in Table 2, appearance of the individual fibers of the pile portion of the obtained pile fabric was extremely inferior.

### COMPARATIVE EXAMPLE 7

70 parts by weight of the fiber obtained in Comparative Example 3 (crimped and cut into 51 mm) was blended with 30 parts by weight of a commercially available acrylic fiber “Kanekalon (trade mark)” SL (SL, 3.3 dtex, 32 mm, available from Kaneka Corporation) to prepare a pile fabric. The final weight (e.g., g/m²) of the pile fabric was 950 g/m² and the average pile length was 20 mm. As shown in Table 2, appearance of the individual fibers of the pile portion of the obtained pile fabric was extremely inferior.

### COMPARATIVE EXAMPLE 8

70 parts by weight of the fiber obtained in Comparative Example 5 (crimped and cut into 51 mm) was blended with 30 parts by weight a commercially available acrylic fiber “Kanekalon (trade mark)” SL (SL, 3.3 dtex, 32 mm, available from Kaneka Corporation) to prepare a pile fabric. The final weight (e.g., g/m²) of the pile fabric was 950 g/m² and the average pile length was 20 mm. As shown in Table 2, appearance of the individual fibers of the pile portion of the obtained pile fabric was extremely inferior.

### COMPARATIVE EXAMPLE 9

70 parts by weight of a commercially available acrylic fiber “Kanekalon (trade mark)” RCL (hereinafter RCL, 17 dtex, 51 mm, available from Kaneka Corporation) were blended with 30 parts by weight of a commercially available acrylic fiber “Kanekalon (trade mark)” SL (SL, 3.3 dtex, 32 mm, available from Kaneka Corporation) to prepare a pile fabric. The final weight (e.g., g/m²) of the pile fabric was 950 g/m² and the average pile length was 20 mm.

As shown in Table 2, appearance of the individual fibers of the pile portion of the obtained pile fabric was extremely inferior.

### COMPARATIVE EXAMPLE 10

70 parts by weight of a commercially available acrylic fiber “FUNCLE (trade mark)” H105 (hereinafter H105, 11 dtex, 51 mm, available from Mitsubishi Rayon Co., Ltd.) was blended with 30 parts by weight of a commercially available acrylic fiber “Kanekalon (trade mark)” SL (SL, 3.3 dtex, 32 mm, available from Kaneka Corporation) to prepare a pile fabric. The final weight (e.g., g/m²) of the pile fabric was 950 g/m² and the average pile length was 20 mm.

As shown in Table 2, appearance of the individual fibers of the pile portion of the obtained pile fabric was extremely inferior.

TABLE 2

| | Proportion of | | Average | Pile fabric | | | | |
|---|---|---|---|---|---|---|---|---|
| | fiber used | Structure | pile length | Weight | Reflec- | Bright- | | Appearance |
| | (part by weight) | of pile | (mm) | (g/m²) | tance | ness | L_{A}/L₁ | property |
| Ex. 6 | Ex. 1/SL = 70/30 | Plain pile of | 20 | 950 | 86.1 | 94.4 | 94.8/92.1 | ◯ |
| | | even length | | | | | | |
| Ex. 7 | Ex. 2/SL = 70/30 | Plain pile of | 20 | 950 | 81.6 | 92.4 | 93.6/92.1 | ◯ |
| | | even length | | | | | | |
| Ex. 8 | Ex. 3/SL = 70/30 | Plain pile of | 20 | 950 | — | — | — | ◯ |
| | | even length | | | | | | |
| Ex. 9 | Ex. 5/SL = 70/30 | Plain pile of | 20 | 950 | 86.9 | 95.2 | 95.1/92.1 | ◯ |
| | | even length | | | | | | |
| Com. | Com. Ex. 1/ | Plain pile of | 20 | 950 | 74.3 | 89.1 | 85.1/92.1 | X |
| Ex. 6 | SL = 70/30 | even length | | | | | | |
| Com. | Com. Ex. 3/ | Plain pile of | 20 | 950 | 75.0 | 89.9 | 92.2/92.1 | X |
| Ex. 7 | SL = 70/30 | even length | | | | | | |
| Com. | Com. Ex. 5/ | Plain pile of | 20 | 950 | 80.5 | 91.9 | 93.9/92.1 | X |
| Ex. 8 | SL = 70/30 | even length | | | | | | |
| Com | RCL/SL = 70/30 | Plain pile of | 20 | 950 | 74.5 | 89.2 | 91.9/92.1 | X |
| Ex. 9 | | even length | | | | | | |
| Com | H105/SL = 70/30 | Plain pile of | 20 | 950 | 79.3 | 91.4 | 93.2/92.1 | X |
| Ex. 10 | | even length | | | | | | |

### EXAMPLE 10

30 parts by weight of the acrylic fiber obtained in Example 1 (crimped and cut into 51 mm) was blended with 50 parts by weight of a commercially available acrylic fiber “Kanekalon (trade mark)” RLM (BR517) (hereinafter RLM, 12 dtex, 44 mm, available from Kaneka Corporation) and 20 parts by weight of a commercially available acrylic fiber “Kanekalon (trade mark)” AHD (10) (heat-shrinkable fiber, hereinafter AHD, 4.4 dtex, 32 mm, available from Kaneka Corporation) to prepare a pile fabric. The final weight (e.g., g/m²) of the pile fabric was 950 g/m², the average pile length was 20 mm and the step was 6 mm.

### EXAMPLE 11

10 parts by weight of the acrylic fiber obtained in Example 1 (crimped and cut into 51 mm) was blended with 70 parts by weight of a commercially available acrylic fiber “Kanekalon (trade mark)” RLM (BR517) (RLM, 12 dtex, 44 mm, available from Kaneka Corporation) and 20 parts by weight of a commercially available acrylic fiber “Kanekalon (trade mark)” AHD (10) (heat-shrinkable fiber, AHD, 4.4 dtex, 32 mm, available from Kaneka Corporation) to prepare a pile fabric. The final weight (e.g., g/m²) of the pile fabric was 950 g/m², the average pile length was 20 mm and the step was 6 mm.

### COMPARATIVE EXAMPLE 11

2 parts by weight of the acrylic fiber obtained in Example 1 (crimped and cut into 51 mm) was blended with 78 parts by weight of a commercially available acrylic fiber “Kanekalon (trade mark)” RLM (BR517) (RLM, 12 dtex, 44 mm, available from Kaneka Corporation) and 20 parts by weight of a commercially available acrylic fiber “Kanekalon (trade mark)” AHD (10) (heat-shrinkable fiber, AHD, 4.4 dtex, 32 mm, available from Kaneka Corporation) to prepare a pile fabric. The final weight (e.g., g/m²) of the pile fabric was 950 g/m², the average pile length was 20 mm and the step was 6 mm.

TABLE 3

| | | | | Long pile portion | | Pile fabric | | | | |
|---|---|---|---|---|---|---|---|---|---|---|
| | Proportion | Proportion | | Proportion | | | | | | |
| | of fiber | of long pile | | of fiber of | Average | | | | | |
| | used | /short pile | | Example 1 | pile | | | | L_{A}/L₁ | |
| | (part by | (% by | Step* | (% by | length | Weight | Reflec- | Bright- | and | Appearance |
| | weight) | weight) | (mm) | weight) | (mm) | (g/m²) | tance | ness | L_{A}/L₁ | property |
| Ex. 10 | Ex. 1/RLM/ | 80/20 | 6 | 37.5 | 20 | 950 | 21.7 | 53.9 | 94.8/29.6 | ◯ |
| | AHD = | | | | | | | | 94.8/14.2 | |
| | 30/50/20 | | | | | | | | | |
| Ex. 11 | Ex. 1/RLM/ | 80/20 | 6 | 12.5 | 20 | 950 | — | — | 94.8/29.6 | ◯ |
| | AHD = | | | | | | | | 94.8/14.2 | |
| | 10/70/20 | | | | | | | | | |
| Com. | Ex. 1/RLM/ | 80/20 | 6 | 2.5 | 20 | 950 | 16.0 | 47.1 | 94.8/29.6 | X |
| Ex. 11 | AHD = | | | | | | | | 94.8/14.2 | |
| | 2/78/20 | | | | | | | | | |

*Step: Difference of average pile length of long pile and short pile

As shown in Table 3, the pile fabric obtained in Examples 10 and 11 exhibited excellent appearance properties that the individual fibers were clearly perceived visually, whereas appearance of the individual fibers of the pile portion was extremely inferior in Comparative Example 11.

### EXAMPLE 12

10 parts by weight of the acrylic fiber obtained in Example 1 (crimped and cut into 51 mm) was blended with 90 parts by weight of a commercially available acrylic fiber “Kanekalon (trade mark)” AHD (10) (heat shrinkable fiber, AHD, 4.4 dtex, 32 mm, available from Kaneka Corporation) to prepare a pile fabric. The final weight (e.g., g/m²) of the pile fabric was 880 g/m², the average pile length was 15 mm and the step was 4 mm.

### COMPARATIVE EXAMPLE 12

2 parts by weight of the acrylic fiber obtained in Example 1 (crimped and cut into 51 mm) was blended with 98 parts by weight of a commercially available acrylic fiber “Kanekalon (trade mark)” AHD (10) (heat shrinkable fiber, AHD, 4.4 dtex, 32 mm, available from Kaneka Corporation) to prepare a pile fabric. The final weight (e.g., g/m²) of the pile fabric was 880 g/m², the average pile length was 15 mm and the step was 4 mm.

### EXAMPLE 13

30 parts by weight of the acrylic fiber obtained in Example 1 (crimped and cut into 76 mm) was blended with 70 parts by weight of a commercially available acrylic fiber “Kanekalon (trade mark)” AH (740) (hereinafter AH, 5.6 dtex, 38 mm, available from Kaneka Corporation) to prepare a pile fabric. The final weight (e.g., g/m²) of the pile fabric was 900 g/m², the average pile length was 47 mm and the step was 25 mm.

### EXAMPLE 14

10 parts by weight of the acrylic fiber obtained in Example 1 (crimped and cut into 76 mm) was blended with 20 parts by weight of a commercially available acrylic fiber “Kanekalon (trade mark)” RCL (RCL, 17 dtex, 51 mm, available from Kaneka Corporation) and 70 parts by weight of a commercially available acrylic fiber “Kanekalon (trade mark)” AH (740) (AH, 5.6 dtex, 38 mm, available from Kaneka Corporation) to prepare a pile fabric. The final weight (e.g., g/m²) of the pile fabric was 900 g/m², the average pile length was 47 mm and the step was 25 mm.

TABLE 4

| | | | | Long pile portion | | Pile fabric | | | | |
|---|---|---|---|---|---|---|---|---|---|---|
| | Proportion | Proportion of | | Proportion | | | | | | |
| | of fiber | long pile/ | | of fiber of | Average | | | | | |
| | used | short pile | | Example 1 | pile | | | | L_{A}/L₁ | |
| | (part by | (% by | Step | (% by | length | Weight | Reflec- | Bright- | and | Appearance |
| | weight) | weight) | (mm) | weight) | (mm) | (g/m²) | tance | ness | L_{A}/L₂ | Property |
| Ex. 12 | Ex. 1/AHD = | 10/90 | 4 | 100 | 15 | 880 | 14.8 | 46.0 | 94.8/14.2 | ◯ |
| | 10/90 | | | | | | | | | |
| Com. | Ex. 1/AHD = | 2/98 | 4 | 100 | 15 | 880 | 10.5 | 38.8 | 94.8/14.2 | Δ |
| Ex. 12 | 2/98 | | | | | | | | | |
| Ex. 13 | Ex. 1/AH = | | | | | | | | | |
| | 30/70 | 30/70 | 25 | 100 | 47 | 900 | — | — | — | ◯ |
| Ex. 14 | Ex. 1/ | 30/70 | 25 | 33.3 | 47 | 900 | — | — | 94.8/91.9 | ◯ |
| | RCL/AH = | | | | | | | | 94.8/17.1 | |
| | 10/20/70 | | | | | | | | | |

As shown in Table 4, the pile fabric obtained in Examples 12 to 14 exhibited excellent appearance properties that the individual fibers were clearly perceived visually, whereas appearance of the individual fibers of the pile portion was extremely inferior in Comparative Example 12.

### INDUSTRIAL APPLICABILITY

Since the acrylic fiber of the present invention has a specific light transmittance and maximum surface reflectance, a pile fabric having excellent appearance properties that the individual fibers are clearly perceived visually can be obtained. As a result, a wide range of novel planning of products such as clothing materials, toys (stuffed dolls) and interior goods become possible. Furthermore, the acrylic fiber has excellent stability in the production steps, excellent productivity and good quality, and is thus extremely useful industrially.

1. A synthetic acrylic fiber comprising an acrylic copolymer, which has a light transmittance of 15 to 65% in the fiber width direction and a maximum surface reflectance of 30 to 80% with respect to light incident thereon at an angle of 60 degrees in the fiber length direction.

2. The acrylic fiber of claim 1, which contains 1.2 to 30 parts by weight of white pigment having a maximum particle size of at most 0.8 μm based on 100 parts by weight of said acrylic copolymer.

3. The acrylic fiber of claim 1, wherein said white pigment is titanium oxide.

4. The acrylic fiber of claim 1, said acrylic copolymer comprising 35 to 98% by weight of acrylonitrile, 65 to 2% by weight of another vinyl monomer copolymerizable with acrylonitrile and 0 to 10% by weight of a sulfonic acid group-containing vinyl monomer copolymerizable therewith.

5. The acrylic fiber of claim 4, wherein the other vinyl monomer copolymerizable with acrylonitrile is vinyl chloride and/or vinylidene chloride.

6. The acrylic fiber of claim 1, wherein said fiber has a flat cross section with a flating ratio of 7 to 25, said flating ratio being the ratio of the minimum value of the long axis to the maximum value of the short axis.

7. The acrylic fiber of claim 6, wherein the flating ratio is 10 to 20.

8. A pile fabric containing, in the pile portion, at least 3% by weight of the acrylic fiber of claim 1 based on the entire pile portion.

9. A pile fabric containing, in the pile portion, at least 3% by weight of the acrylic fiber of claim 2 based on the entire pile portion.

10. A pile fabric containing, in the pile portion, at least 3% by weight of the acrylic fiber of claim 3 based on the entire pile portion.

11. A pile fabric containing, in the pile portion, at least 3% by weight of the acrylic fiber of claim 6 based on the entire pile portion.

12. A pile fabric containing, in the pile portion, at least 3% by weight of the acrylic fiber of claim 7 based on the entire pile portion.

13. The pile fabric of claim 8, wherein the hue L_{A} of the acrylic fiber and the hue Lᵢ of fiber other than the acrylic fiber satisfy |L_{A}−Lᵢ>30.

14. A step pile fabric having at least a long pile portion and a short pile portion, wherein the long pile portion contains the acrylic fiber of claim 1.

15. The step file fabric of claim 14, which comprises 5 to 60% by weight of said acrylic fiber based on the entire pile portion.

16. The step file fabric of claim 14, wherein the difference between the pile length of the fiber of the long pile portion and the pile length of the fiber of the short pile portion is at least 2 mm, and the pile length of the fiber of the long pile portion is 12 to 70 mm.

17. The step file fabric of claim 14, wherein the hue L_{A} of the acrylic fiber and the hue Lᵢ of fiber other than the acrylic fiber satisfy L_{A}−Lᵢ>30.
